(19) United States
(12) Patent Application Publication
(10) Pub. No.: US 2007/0220856 A1
(43) Pub. Date: Sep. 27, 2007

(54) Metal fiber media, filter for exhaust gas purifier using the same as filter member, and method for manufacturing the filter

(75) Inventors: Eun-Rae Cho, Seoul (KR); Man-Ho Park, Seoul (KR); Kwang-Hyun Park, Seoul (KR); Duck-Eui Lee, Gyunggi-do (KR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Fiber Tech Co., Ltd., Gyunggi-do (KR)

(21) Appl. No.: 11/726,486

(22) Filed: Mar. 22, 2007

(30) Foreign Application Priority Data
Mar. 23, 2006 (KR) 10-2006-26649
Mar. 20, 2007 (KR) 10-2007-27289

(51) Int. Cl. B01D 24/00

(52) U.S. Cl. 55/525

(57) ABSTRACT

A metal fiber media exhibiting superior durability, mechanical strength, and heat transfer efficiency, a filter for an exhaust gas purifier using the same as a filter member, and a method for manufacturing the filter are disclosed. The metal filter media includes a metal fiber mat made of longitudinally-aligned metal fiber yarns each including a bundle of 20 to 500 uniformly-oriented metal fibers and having a length of 0.45 to 0.6 m per 1 g, and a torsion of 1 to 9 turns/m such that the metal fiber mat has a porosity of 30 to 95%, and supports respectively attached to upper and lower surfaces of the metal fiber mat, the supports having a porosity of 5 to 95%. Since the metal fiber media exhibits excellent durability and mechanical strength, no crack is generated in the metal fiber medial due to external impact. Accordingly, there is no possibility of damage. Since the metal fiber media has excellent heat transfer efficiency, uniform heat transfer is achieved during regeneration of the filter. Accordingly, there is no damage of the filter caused by local heating. It is also possible to prevent the material of the filter from being melted. Excellent workability and particulate matter collection efficiency are obtained.

### CLAIM OF PRIORITY

This application claims the benefit of Korean Patent Application No. 2006-26649 filed on Mar. 23, 2006 and 2007-27289 filed on Mar. 20, 2007, in the Korean Intellectual Property Office, the disclosure of which is incorporated herein by reference.

### BACKGROUND OF THE INVENTION

1. Field of the Invention

The present invention relates to a metal fiber media, a filter for an exhaust gas purifier using the same as a filter member, and a method for manufacturing the filter, and more particularly to a metal fiber media exhibiting superior durability, mechanical strength, and heat transfer efficiency, a filter for an exhaust gas purifier using the same as a filter member, and a method for manufacturing the filter.

2. Description of the Related Art

Although diesel engines have the advantages of high thermal efficiency and superior durability, they emit a large amount of particulate matter (PM) and nitrogen oxide (NOₓ). Such PM and nitrogen oxide pollute the air. In particular, particulate matter is very harmful to the human body because it exhibits a high adsorption rate. Recently, the emission of particulate matter and nitrogen oxide from diesel vehicles has greatly increased, such that it becomes a serious issue in our society. To this end, the Diesel Vehicle Environmental Protection Committee in the Ministry of Environmental Protection in Korea has recently established a scheme to tighten the allowance standards for the emission of exhaust gas and to enforce attachment of a smoke post-treating device (diesel PM filter (DPF) or diesel oxidation catalyst (DOC)) when diesel cars are sold.

Particulate matter contained in exhaust gas emitted from a diesel engine includes sulfur-containing particulates such as sulfate particulates and high-molecular hydrocarbon particulates. When such particulate matter is emitted into the air, it floats in the air because it is light, thereby causing environmental pollution, reduced visibility, chest trouble, etc. Conventionally, such particulate matter, which is contained in diesel engine exhaust gas, has been removed using a DPF.

DPF collects particulate matter contained in diesel engine exhaust gas, to reduce the emission of particulate matter. However, the filter may be blocked after a certain period of use, due to an increase in the amount of particulate matter collected in the filter. In this case, the differential pressure of the exhaust gas increases, thereby causing an increase in the negative pressure of the engine. As a result, the performance of the engine is degraded. In order to recover the performance of the filter, namely, to regenerate the filter, hydrocarbon soot caught by the filter is burnt.

In association with use of a DPF, it is most important to remove particulate matter accumulated in the DPF, namely to regenerate the DPF. For a general filter regeneration method, there is a method using a catalyst or a method using the application of external energy to burn PM, and thus to remove the PM. In association with removal of PM contained in diesel engine exhaust gas using the DPF and regeneration of the DPF, performances required in the DPF are (1) filtering efficiency (PM collection rate, etc.), (2) heat resistance, (3) thermal expansion coefficient, (4) thermal impact, mechanical strength and durability, and (5) differential pressure characteristics. However, there are problems of degradation in thermal impact resistance and degradation in durability caused by heating the DPF.

Meanwhile, for filter materials of conventional DPFs, cordierite and SiC, which are ceramic materials, and a sintered metal mat have been used.

Cordierite is a ceramic material having a composition of 2MgO-2Al₂O₃-5SiO₂. The cordierite filter exhibits superior strength, and is stably usable in temperatures up to about 1,200° C. An example of the cordierite filter is a product manufactured by Corning Inc. However, such a cordierite filter has a problem associated with durability because it exhibits a low heat transfer rate in a region where the amount of accumulated particulate matter is large, so that it may be locally melted in the region due to heat generated during a regeneration process.

A filter made of SiC has been developed to overcome drawbacks of the cordierite filter caused by the melting phenomenon and thermal impact at high temperature. Although the SiC filter exhibits superior heat resistance and mechanical strength, it has drawbacks in that its material is expensive, and it needs sintering at high temperature causing complexity of the manufacturing process.

Meanwhile, sintered metal mats or metal powder sintered products have been mainly used for filter materials by German filter manufacturers. For example, a method for manufacturing a filter layer using sintered metal fibers is disclosed in Korean Patent Unexamined Publication No. 2005-30223 issued in the name of EMITEC GESELLSCHAFT FUR EMISSIONSTECHNOLOGIE MBH. In the case of a filter made of a sintered metal mat, there is a problem associated with workability in that the sintered metal mat may be easily broken at bent portions formed when the sintered metal mat is shaped into the filter, because the metal is rendered fragile due to sintering.

As apparent from the above description, the above-mentioned ceramic filters have problems in that cracks may be formed when they are subjected to impact, and they may be melted due to local heating thereof. Also, the above-mentioned sintered metal mat has the problem of low workability. Therefore, a filter for diesel engine exhaust gas exhibiting excellent characteristics in terms of durability, mechanical strength and heat transfer efficiency is needed.

### SUMMARY OF THE INVENTION

The present invention has been made to solve the foregoing problems of the related art, and therefore an aspect of the present invention is to provide a metal fiber media for removal of particulate matter from diesel engine exhaust gas which exhibits excellent characteristics in terms of durability, mechanical strength, and heat transfer efficiency.

Another aspect of the present invention is to provide a filter for an exhaust gas purifier which uses, as a filter member, the metal fiber media exhibiting excellent characteristics in terms of durability, mechanical strength, and heat transfer efficiency.

Another aspect of the present invention is to provide a method for manufacturing the filter exhibiting excellent characteristics in terms of durability, mechanical strength, and heat transfer efficiency.

In accordance with a first aspect, the present invention provides a metal fiber media comprising: a metal fiber mat made of a plurality of unidirectionally-oriented metal fibers, the metal fiber mat having a porosity of 30 to 95%; and supports respectively attached to upper and lower surfaces of the metal fiber mat, the supports having a porosity of 5 to 95%.

In accordance with a second aspect, the present invention provides a metal fiber media comprising: a metal fiber mat made of longitudinally-aligned metal fiber yarns each including a bundle of 20 to 500 uniformly-oriented metal fibers and having a length of 0.45 to 0.6 m per 1 g, and a torsion of 1 to 9 turns/m, the metal fiber mat having a porosity of 30 to 95%; and supports respectively attached to upper and lower surfaces of the metal fiber mat, the supports having a porosity of 5 to 95%.

In accordance with a third aspect, the present invention provides a filter for an exhaust gas purifier comprising: a metal fiber media as a filter member, the metal fiber media comprising a metal fiber mat made of a plurality of unidirectionally-oriented metal fibers, the metal fiber mat having a porosity of 30 to 95%, and supports respectively attached to upper and lower surfaces of the metal fiber mat, the supports having a porosity of 5 to 95%.

In accordance with a fourth aspect, the present invention provides a filter for an exhaust gas purifier comprising: a metal fiber mat as a filter member, the metal fiber media comprising a metal fiber mat made of longitudinally-aligned metal fiber yarns each including a bundle of 20 to 500 uniformly-oriented metal fibers and having a length of 0.45 to 0.6 m per 1 g, and a torsion of 1 to 9 turns/m, the metal fiber mat having a porosity of 30 to 95%, and supports respectively attached to upper and lower surfaces of the metal fiber mat, the supports having a porosity of 5 to 95%.

In accordance with a fifth aspect, the present invention provides a method for manufacturing a filter for an exhaust gas purifier, comprising: manufacturing a metal fiber mat made of a plurality of unidirectionally-oriented metal fibers and having a porosity of 30 to 95%; attaching supports having a porosity of 5 to 95% to upper and lower surfaces of the metal fiber mat, respectively, to manufacture a metal fiber media; shaping the metal fiber media into a filter member having a predetermined shape; and fixing fixing members to opposite ends of the filter member, respectively.

In accordance with a sixth aspect, the present invention provides a method for manufacturing a filter for an exhaust gas purifier, comprising: manufacturing a metal fiber mat made of longitudinally-aligned metal fiber yarns each including a bundle of 20 to 500 uniformly-oriented metal fibers and having a length of 0.45 to 0.6 m per 1 g, and a torsion of 1 to 9 turns/m such that the metal fiber mat has a porosity of 30 to 95%; attaching supports having a porosity of 5 to 95% to upper and lower surfaces of the metal fiber mat, respectively, to manufacture a metal fiber media; shaping the metal fiber media into a filter member having a predetermined shape; and fixing fixing members to opposite ends of the filter member, respectively.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating constituent elements of a metal fiber media according to the present invention and a method for manufacturing the metal fiber media;

FIG. 2A is a schematic view illustrating a metal fiber mat made of unidirectionally-oriented metal fibers according to an embodiment of the present invention;

FIG. 2B is a schematic view illustrating a metal fiber mat made of longitudinally-arranged metal fiber yarns according to another embodiment of the present invention;

FIG. 2C is a schematic view illustrating a metal fiber mat made of two layers of longitudinally-arranged metal fiber yarns according to another embodiment of the present invention;

FIG. 3 is a schematic view illustrating an apparatus for melt extrusion of metal fibers used in the present invention;

FIG. 4A is a photograph illustrating randomly-oriented metal fibers manufactured in accordance with a melt extraction process;

FIG. 4B is an SEM photograph (×200) illustrating cross-sections of metal fibers manufactured in accordance with the melt extraction process;

FIG. 4C is an SEM photograph (×600) illustrating side surfaces of metal fibers manufactured in accordance with the melt extraction process;

FIG. 5A is a schematic view illustrating a method for manufacturing a corrugated metal fiber media (filter member) in accordance with an embodiment of the present invention;

FIG. 5B is a schematic view illustrating the manufacturing method for the corrugated metal fiber media (filter member) in accordance with the embodiment of the present invention;

FIG. 6A is a photograph illustrating a corrugated tubular filter according to an embodiment of the present invention;

FIG. 6B is a cross-sectional view taken along the line B-B of FIG. 6A;

FIG. 7A is a photograph illustrating a corrugated multi-tubular filter according to another embodiment of the present invention;

FIG. 7B is a cross-sectional view taken along the line C-C of FIG. 7A;

FIG. 8 is a schematic view illustrating a position where a low-density portion (B) is formed in the filter of the present invention;

FIG. 9 is a schematic view illustrating a phenomenon that particulate matter contained in exhaust gas is filtered out by the filter of the present invention;

FIG. 10 is a graph depicting measurement conditions in Example 2;

FIG. 11 is a graph depicting the generation degree of particulate matter when no DPF is used in Example 2;

FIG. 12 is a graph illustrating the particulate matter collection efficiency of each filter in Example 2;

FIG. 13 is a graph depicting a variation in the particulate matter collection efficiency of each filter depending on the lapse of time in Example 3;

FIG. 14 is a graph depicting a variation in differential pressure (DP, back pressure) occurring in each filter during filter regeneration in Example 4;

FIG. 15 is a graph depicting a maximum differential pressure (DP) generated in each filter after filter regeneration in Example 5; and

FIG. 16 is a graph depicting the differential pressure characteristics of the filter having the low-density portion in Example 6.

### DETAILED DESCRIPTION OF THE PREFERRED EMBODIMENTS

Exemplary embodiments of the present invention will now be described in detail with reference to the accompanying drawings.

Conventionally, cordierite, which is a kind of a ceramic material, and a sintered metal mat have mainly been used as the material for a filter which is an essential element of a diesel particulate matter (PM) filter (DPF) used to remove PM and nitrogen oxide (NOₓ) contained in diesel engine exhaust gas. However, in the case of a cordierite filter, cracks maybe formed when the cordierite filter is subjected to impact (vibrations), so that the cordierite filter may be damaged. Furthermore, in the burning process to regenerate the filter, the filter heat may concentrate in local areas due to the degraded heat transfer rate thereof. In this case, the filter may be melted or damaged without being efficiently regenerated. In the case of a sintered metal mat, there is a problem of low workability in that the sintered metal mat may be easily broken at bent portions formed when the sintered metal mat is shaped into a desired filter structure, because the metal is rendered fragile due to sintering. Therefore, a filter material for an exhaust gas purifier exhibiting excellent characteristics in terms of durability, mechanical strength and heat transfer efficiency is needed.

The present invention provides a filter for an exhaust gas purifier which uses a metal fiber media as a filter member. Since the filter is made of a metal material, it has superior durability, mechanical strength, and heat transfer efficiency. Since the metal filter media of the present invention exhibits excellent durability and mechanical strength, there is no formation of cracks caused by external impact. Also, there is no possibility of breakage. In the burning process to regenerate of the filter, heat is uniformly transferred to the overall portion of the filter because the filter has excellent transfer efficiency. Accordingly, there is no phenomenon that the filter is broken or melted due to local heating thereof. Thus, an excellent filter regeneration effect is obtained. Moreover, the metal fiber media exhibits superior workability because the metal thereof is not rendered fragile in that they are manufactured without being subjected to a sintering process. Also, the metal fiber media exhibits superior smoke/PM collection efficiency because it can achieve a three-dimensional depth filter effect. In addition, the filter made of the metal fiber media according to the present invention exhibits collection efficiency for particulate matter contained in diesel engine exhaust gas and regeneration efficiency equal to those of the conventional filters made of cordierite and sintered metal mat.

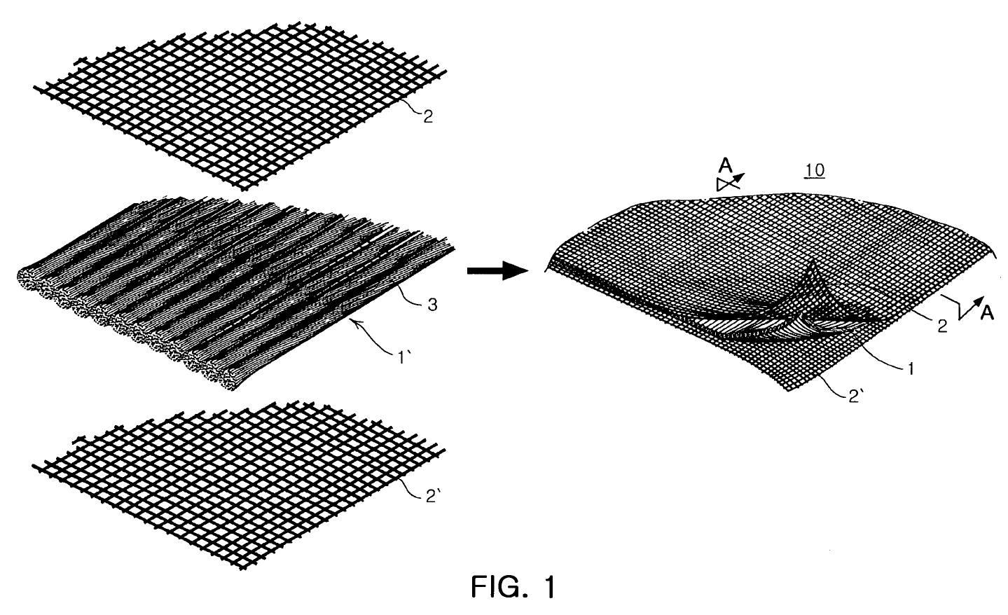

FIG. 1 illustrates a metal fiber media 10 according to an exemplary embodiment of the present invention. As shown in FIG. 1, the metal fiber media 10 of the present invention includes a metal fiber mat 1′ and supports 2 and 2′ respectively attached to upper and lower surfaces of the mat 1′.

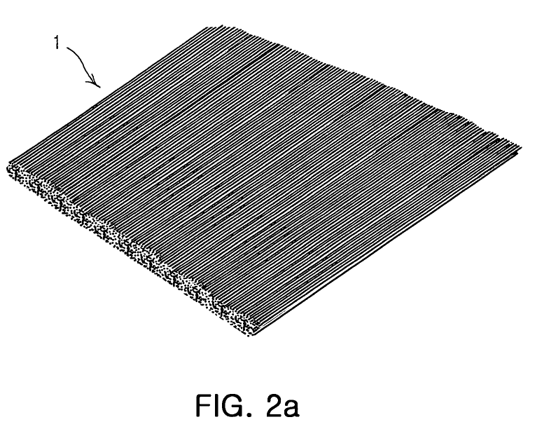

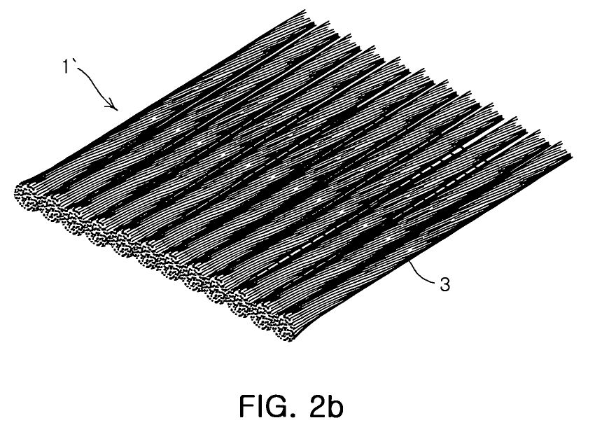

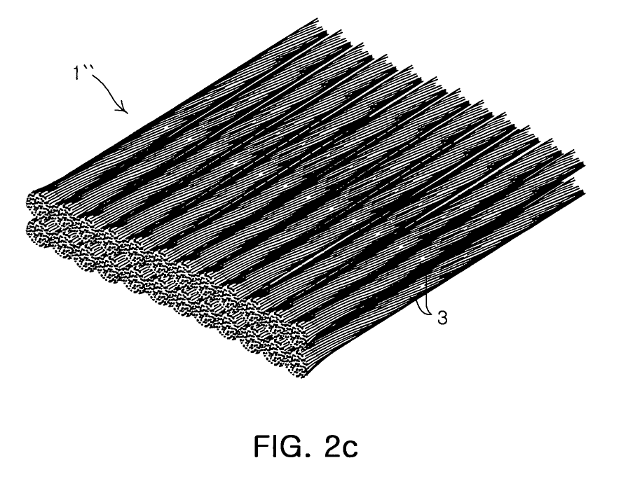

The metal fiber mat 1′ may be made of metal fibers or yarns made of the metal fiber. Various types of metal fiber mats usable for the metal fiber media 10 of the present invention are illustrated in FIGS. 2A to 2C. There is no particular limitation on the metal fibers used in the manufacture of the metal fiber mat. Any metal fibers may be used. The metal fibers are aligned in one direction so that they are unidirectionally oriented. For an example of the metal fibers usable in the present invention, metal fibers may be used which are prepared by combing randomly-oriented metal fibers manufactured by a melt extraction method such that the metal fibers are unidirectionally oriented.

FIG. 2A illustrates a heat-resistant metal fiber mat prepared by combing randomly-oriented metal fibers manufactured by a melt extraction method such that the metal fibers are unidirectionally oriented.

FIG. 2B is a perspective view illustrating a metal fiber mat made of longitudinally-aligned metal fiber yarns in accordance with an embodiment of the present invention. The metal fiber mat of FIG. 2B includes metal fiber yarns 3, each of which is formed by a bundle of 20 to 500 metal fibers prepared by continuously combing several times randomly-oriented metal fibers manufactured by a melt extraction method such that the metal fibers are unidirectionally oriented. The metal fiber yarns 3 have a length of 0.45 to 0.6 m per 1 g, and a torsion of 1 to 9 turns/m.

For the metal fibers, metal fibers having an equivalent diameter of 10 to 150 μm are preferable. Metal fibers having an equivalent diameter of less than 10 μm are undesirable because they may be easily cut during the combing process. Metal fibers having an equivalent diameter of more than 150 μm are also undesirable because it is difficult to form yarns using the metal fibers in that the number of metal fibers is too small to form a yarn structure in this case. It is also preferable to use metal fibers having a length of 10 to 20 cm. Metal fibers having a length of less than 10 cm are undesirable because the length is too small to form yarns. On the other hand, it is difficult to manufacture metal fibers having a diameter of 10 to 150 μm such that the metal fibers have a length of more than 20 cm, using a melt extraction process.

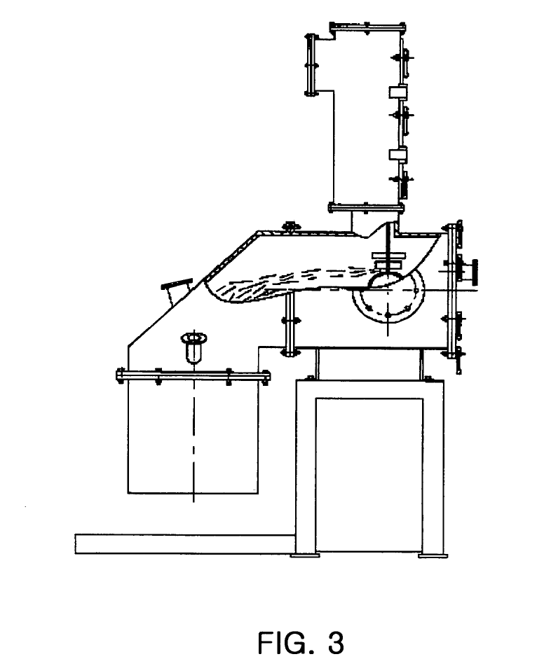

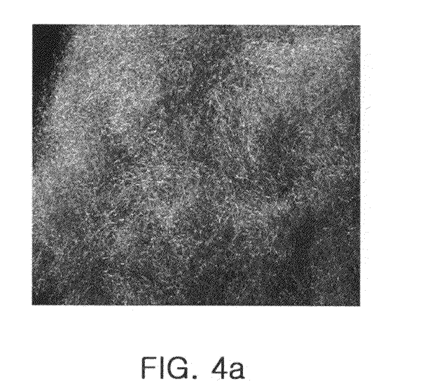

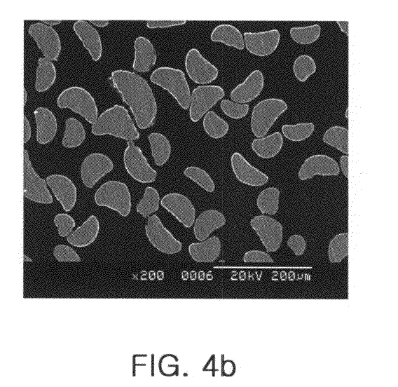

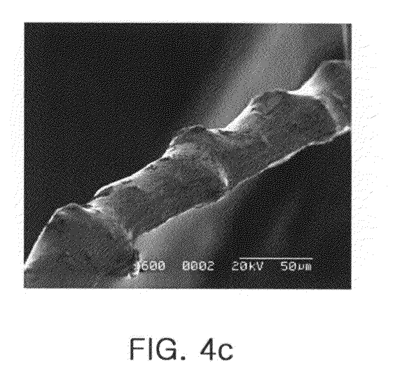

The melt extraction process is a method which comprises positioning a circular rod having a diameter 12 mm near an induction coil of a melting means, to melt an end of the rod, and bring the melted portion of the rod into contact with a disc rotating at a high speed of 1 to 100 m/sec, to instantaneously extract a metal fiber having a diameter of 20 to 70 μm. This method disclosed in, for example, U.S. Pat. No. 6,604,570 issued in the name of the present applicant, and may be carried out using an apparatus shown in FIG. 3. Fine metal fibers manufactured using the melt extraction process are randomly arranged without having orientation in a certain direction, namely randomly oriented, as shown in FIG. 4A. The metal fibers have a half-moon-shaped cross section, as shown in FIG. 4B. Each metal fiber has a plurality of protrusions protruded from a peripheral surface of the metal fiber to a height of 1 to 5 μm, as shown in FIG. 4C.

In order to prepare the metal fiber mat of the present invention using the randomly-oriented metal fibers manufactured in accordance with the melt extraction process, it is necessary to provide certain directionality to the metal fibers. The directionality to arrange the fine metal fibers in one direction in parallel can be provided by continuously combing the randomly-oriented metal fibers several times. Thus, it is possible to obtain the metal fiber mat 1 as shown in FIG. 2A by combing randomly-oriented metal fibers manufactured in accordance with the melt extraction process such that the metal fibers are unidirectionally oriented.

Meanwhile, when yarns are prepared using the metal fibers, the process to provide the unidirectional orientation is repeatedly carried out until about 20 to 500 metal fibers are bundled into one yarn. Using less than 20 metal fibers, it is difficult to form a yarn because the metal fibers are not entangled enough due to the insufficient number thereof. On the other hand, when the number of metal fibers in one yarn is more than 500, an excessive differential pressure may be generated in the final-manufactured filter due to the excessive number of metal fibers. In this case, there is another problem of an increase in the thickness and weight of the filter. There is no particular limitation on the metal fibers used to manufacture the yarns. Any metal fibers may be used. Although not limited thereto, metal fibers may be used which are prepared by combing randomly-oriented metal fibers manufactured in accordance with a melt extraction process such that the metal fibers are unidirectionally oriented.

The metal fibers obtained in accordance with the melt extraction process can be easily formed into yarns, as compared to metal fibers manufactured using a conventional machining method, because it is possible to avoid separation of metal fibers during the manufacture of yarns by virtue of the protrusions protruded from the surfaces of the metal fibers to a height of a micron level. Details can be referred to the disclosure of Korean Patent Application No. 2005-4249.

Meanwhile, the metal fiber yarns used to manufacture the heat-resistant metal fiber mat are manufactured to have a length of 0.45 to 0.6 m per 1 g (0.45 to 0.6 Nm) and a torsion of 1 to 9 turns/m. The yarn length of less than 0.45 m per 1 g is undesirable because a reduction in porosity occurs due to the excessive thickness of the yarn. On the other hand, when the yarn has a length of more than 0.6 m per 1 g, there is a problem in that the yarn is too thin to obtain a uniform thickness.

When a metal fiber mat made of a plurality of unidirectionally-oriented metal fibers as described above or a metal fiber mat made of longitudinally-aligned metal fiber yarns as described above is used to manufacture a filter, the metal fiber mat may have a single or a multilayer structure including two or more longitudinally-laminated layers. For example, the metal fiber mat may have a single layer structure when the thickness of yarns is large, and may have a multilayer structure when the thickness of yarns is small. Also, the metal fiber mat may have a multilayer structure including two or more laminated layers, taking into consideration the physical properties required in accordance with the use purpose of the metal fiber mat. The metal fiber mat 1, which includes a single layer of unidirectionally-oriented metal fibers, is illustrated in FIG. 2A. FIG. 2B illustrates a mat 1′ including a single layer of metal fiber yarns. FIG. 2C illustrates a mat 1″ including two layers of metal fiber yarns. A metal fiber mat formed by laminating the mat which is made of the above-described metal fiber yarns and the mat which is made of a plurality of unidirectionally-oriented metal fibers as described above may also be used.

The metal fibers used to manufacture the metal fiber mat preferably have a density of 100 to 4,000 g/m². The density of less than 100 g/m² is undesirable because the equivalent diameter of pores formed in this case exceeds about 250 μm. The density of more than 4,000 g/m² is also undesirable because it is difficult to form a filter due to the heavy and thick structure of the filter in this case.

For the metal fibers, metal fibers made of Fecralloy containing an iron-chromium-aluminum-based alloy as a major component thereof may be used. Preferably, improved Fecralloy may be used which contains 0.05 to 0.5 wt %, preferably 0.1 to 0.3 wt %, Zr. When a mat made of Fecralloy metal fibers containing Zr in the above-described content range is used as a filtering media, there is the advantage of an excellent oxidation lifespan. Generally, Fecralloy is known. For example, Fecralloy may be used which comprises 13 to 30 wt % chromium (Cr), 3 to 7 wt % aluminum (Al) and remainder of iron(Fe) Fecralloy comprising 0.05 to 0.5 wt % zirconium (Zr), in addition to the above composition, is preferable. Fecralloy comprising 0.1 to 0.3 wt % zirconium (Zr), in addition to the above composition, is more preferable.

Preferably, the metal fiber mat has a porosity of 30 to 95%. When the porosity is less than 30%, an abrupt increase in differential pressure occurs as dust contained in exhaust gas is filtered out. On the other hand, when the porosity is more than 95%, the pores are too large to effectively filter out dust.

Preferably, the metal fiber supports have a porosity of 5 to 95%. When the porosity of the metal fiber supports is less than 5%, an increased strength is obtained, but the differential pressure generated in the filter is excessively high. On the other hand, when the porosity of the metal fiber supports is more than 95%, the differential pressure generated in the filter is low, but a reduction in strength occurs. The upper and lower supports of the metal fiber mat may have the same or different porosities. The supports may also be made of the same material as the metal fibers, namely the above-described Fecralloy. The metal fibers and supports have heat resistance.

As shown in FIG. 1, the metal fiber media 10 is manufactured by attaching wire meshes 2 and 2′, as supports, to the upper and lower surfaces of the mat 1 made of longitudinally-aligned metal fibers (FIG. 2A) or the metal fiber mat 1′ or 1″ made of metal fiber yarns (FIG. 2B or 2C). The wire meshes 2 and 2′ are used to enhance the strength of the metal fiber media 10 while maintaining the shape of the metal fiber mat 1, 1′, or 1″. Since the metal fiber mat 1, 1′ or 1″ is reinforced by the supports 2 and 2′ attached to the upper and lower surfaces of the metal fiber mat 1, 1′ or 1″, the mat state in which the metal fibers or metal fiber yarns are longitudinally aligned is fixed. Accordingly, it is possible to prevent the aligned metal fiber or metal fiber yarns 3 from moving during a subsequent process to shape the mat into a filter having a certain shape. The strength of the metal fiber media 10 also increases.

Preferably, the metal fiber media 10 has a thickness of 0.5 to 3 mm. When the metal fiber media 10 has a thickness of less than 0.5 mm, the porosity thereof is undesirably reduced due to a high fiber density. On the other hand, when the metal fiber media 10 has a thickness of more than 3mm, the porosity thereof is too high to filter out dust.

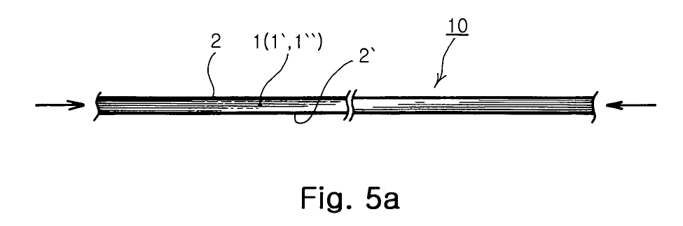

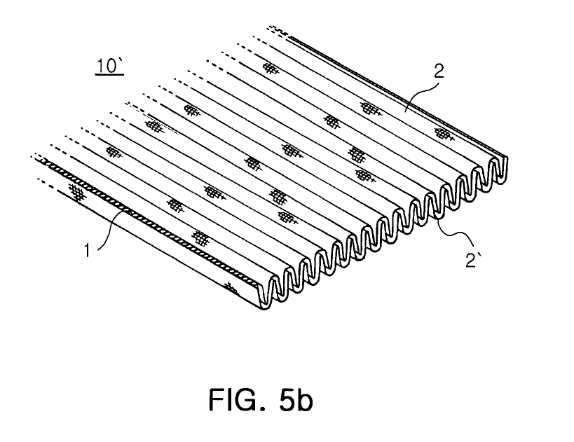

The metal fiber media 10 can be used as a filter member of a filter usable to remove particulate matter contained in diesel engine exhaust gas. The metal fiber media 10 used as the filter member may have a corrugated structure. The corrugated metal fiber media can be manufactured by pleating the metal fiber media in a direction perpendicular to the longitudinal direction of the metal fibers or yarns, to form corrugations, and pressing the pleated metal fiber media in the direction of the corrugations, to fix the corrugations. There is no particular limitation on the metal fiber media to be pleated. Any types of metal fiber media may be pleated to form the corrugated metal fiber media. In detail, it is possible to manufacture a corrugated metal fiber media by pleating the metal fiber media manufactured using one of the metal fiber mats shown in FIGS. 2A to 2C. The manufacturing method for the corrugated metal fiber media and the structure of the manufactured corrugated metal fiber media are shown in FIGS. 5A and 5B, respectively. In the pleating process, forces are applied to opposite longitudinal ends of the metal fiber media 10, as shown in FIG. 5A, to pleat the metal fiber media 10 in a direction perpendicular to the longitudinal direction of the metal fibers or yarns, and thus to form corrugations. Thereafter, the pleated metal fiber media is pressed in a direction of the corrugations, to fix the corrugations. Thus, a metal fiber media 10′ having a thickness approximately equal to the depth of the corrugations is obtained, as shown in FIG. 5B. Preferably, the corrugation depth is 3 to 30 mm. When the corrugation depth is less than 3 mm, no formation of effective corrugations is achieved. In this case, there is no or little surface area increase obtained by corrugations. On the other hand, when the corrugation depth is more than 30 mm, there may be problems of deformation of the media caused by heat generated during a regeneration process or by high pressure. When the corrugation depth is 3 mm, the surface area of the media increases by 1.5 times the surface area obtained before the corrugations are formed. When the corrugation depth is 30 mm, a surface area increase by 15 times is obtained.

The metal fiber media and corrugated metal fiber media according to the present invention may have an average pore size corresponding to an equivalent diameter of 10 to 250 μm. When the equivalent diameter of the average pore size is less than 10 μm, micro dust can be efficiently filtered out, but the pores may be blocked due to collection of micro dust on the surfaces of the filter, thereby causing an abrupt increase in pressure. On the other hand, when the equivalent diameter of the average pore size is more than 250 μm, appropriate filtering characteristics cannot be obtained. In the case of a filter manufactured using the metal fiber media or corrugated metal fiber media, it exhibits a porosity of 85 to 97%.

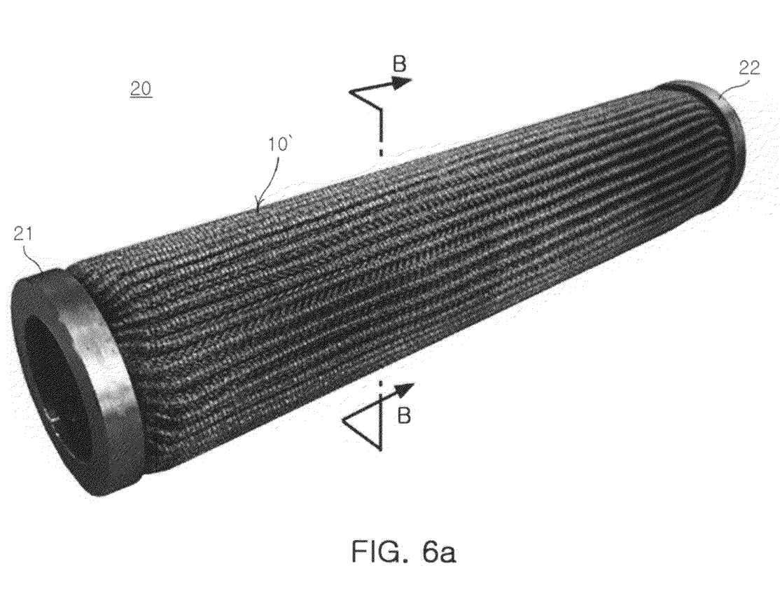

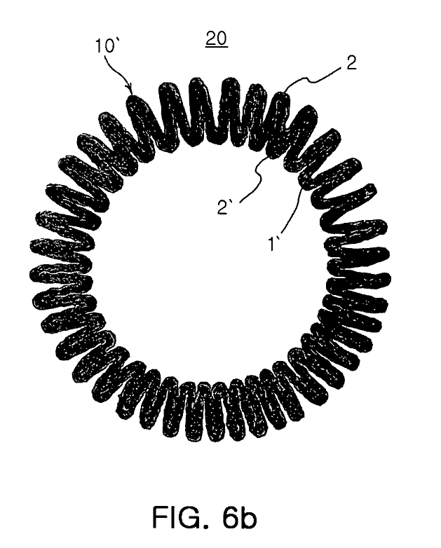

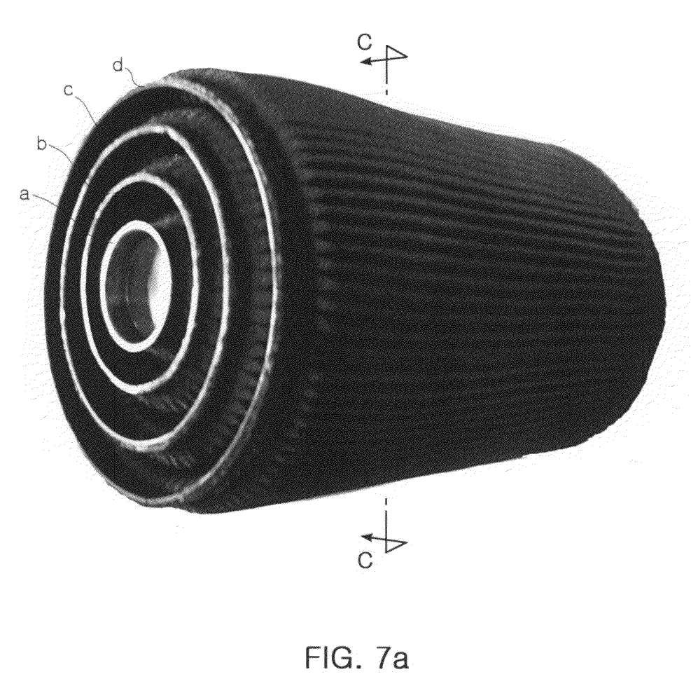

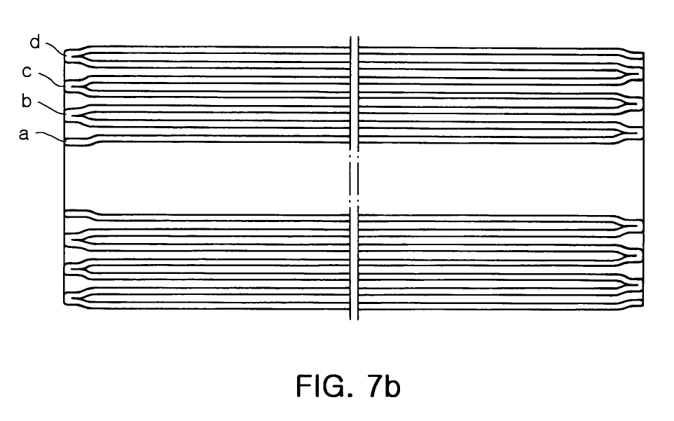

It is possible to manufacture any types of filters usable for removal of particulate matter from diesel engine exhaust gas, using the metal fiber media 10 or 10′ as a filter member. There is no particular limitation on the filter type. The filter may have any shape as long as the surface area in contact with the exhaust gas is as large as possible, and particulate matter can be collected, as much as possible, in pores defined among the metal fibers. Exemplary types of filters are illustrated in FIGS. 6A to 7B, for better understanding of the present invention. However, the present invention is not limited to the illustrated filter types.

The filter may have a tubular structure or may have a multi-tubular structure in which a plurality of tubular filter members are telescopically arranged. The cross section of the tubular filter may be circular, oval, or polygonal such as square or pentagonal. Preferably, the tubular filter has a circular cylinder shape. The multi-tubular filter may include two or more telescopic filter members. There is no particular limitation on the number of the telescopic filter members. The number of the telescopic filter members may be appropriately selected, taking into consideration the efficiency and capacity of the filter. Where the filter member of the tubular filter or each filter member of the multi-tubular filter is made of the above-described corrugated metal media, it may have a corrugated tubular structure, and preferably a corrugated cylindrical structure.

FIGS. 6A and 6B illustrate a filter formed using a corrugated cylindrical filter member. FIG. 6A shows a corrugated cylindrical filter 20 manufactured using a filter member formed by shaping the corrugated metal fiber media according to the above-described embodiment of the present invention into a cylindrical structure. FIG. 6B is a cross-sectional view taken along the line B-B of FIG. 6A. FIG. 6B shows the cross-section of the corrugated cylindrical filter shown in FIG. 6A. Opposite ends of the corrugated cylindrical filter member are retained by fixing members 21 and 22. The fixing members 21 and 22 may have a cap shape, and may be fixed to the opposite ends of the filter member by a welding process.

The entering end of exhaust gas in the filter is opened and the emitting end of the treated gas in the filter is closed.

FIG. 7A shows a multi-tubular cylindrical filter. The filter of FIG. 7A includes a plurality of corrugated tubular filter members which are coaxially telescopically arranged around an axis extending in a flow direction of exhaust gas. The filter members are alternately joined to one another at opposite ends thereof such that the adjacent filter members are joined at only one end of the filter. In the illustrated case, joints a, b, c, and d are formed at each end of the filter in accordance with the joining of the filter members. The joints a, b, c, and d formed at one end of the filter alternate with the joints a, b, c, and d formed at the other end of the filter.

The filter shown in FIGS. 7A and 7B has a multi-tubular structure of 7 filter members each constituted by a corrugated metal fiber media. As shown in FIG. 7B which is a cross-sectional view taken along the line C-C of FIG. 7A, the filter members are alternately joined to one another at opposite ends thereof such that the adjacent filter members are joined at only one end of the filter. Thus, an integrally-joined filter structure is obtained.

In the case of a filter having a tubular structure, it is preferred that the ratio of equivalent diameter to length be 1:1.5 to 15. In the case of a filter having a multi-tubular filter, it is preferred that the equivalent diameter-to-length ratio of the innermost tubular filter member be 1:1.5 to 15. When the length is less than 1.5 times the equivalent diameter, the filtering area is reduced, as compared to the volume of the filter. On the other hand, when the length is more than 15 times the equivalent diameter, the filter is too long to be installed in a vehicle. Preferably, the number of corrugations in the tubular filter member of the tubular filter or in each tubular filter member of the multi-tubular filter is equal or less than 15 times the equivalent diameter of the filter when the equivalent diameter is expressed in centimeters. When the number of corrugations is more than 15 times the equivalent diameter, the spacing between the adjacent corrugations is too narrow to provide a wide filtering surface due to the excessively large number of corrugations.

In accordance with another embodiment of the present invention, a filter is provided that includes a filter member having a low-density portion formed in a portion of the filter member. The filter has a density adjusted such that the density of a portion of the filter member is smaller than the remaining portion of the filter member, and exhibits enhanced differential pressure characteristics.

In the case of a filter for the removal of particulate matter from diesel engine exhaust gas, blocking of the filter, and thus increasing in differential pressure in the filter, may occur due to the collection of particulate matter in the filter. This problem can be solved by adjusting the filter member of the filter such that the density of a portion of the filter member is smaller than the remaining portion of the filter member. That is even when a large amount of particulate matter has been collected in the filter, vaporized particulate materials can be discharged out of the filter through the low-density portion of the filter member. Accordingly, it is possible to reduce the possibility that an increase in differential pressure occurs due to an increased amount of collected particulate matter. In addition, the blocking of the filter by the collected particulate matter is delayed. Accordingly, it is possible to use the filter for an increased period of time and to achieve an enhancement in the PM collection efficiency of the filter.

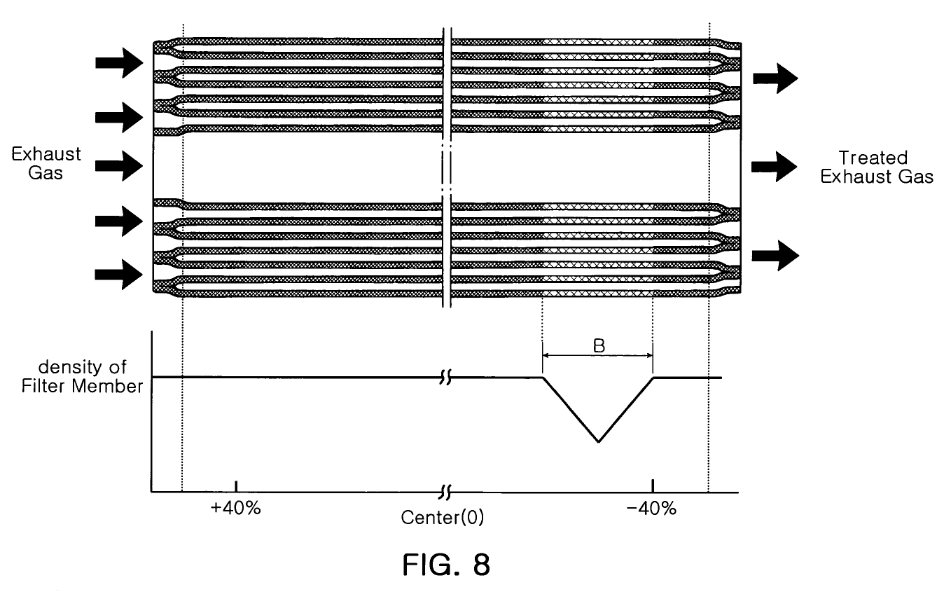

As shown in FIG. 8, a low-density portion B is formed at a portion of the filter arranged within a longitudinal range of ±40% from the center of the filter. When the low-density portion B is formed outside the longitudinal range of ±40% from the center of the filter, for example at the inlet or outlet of the filter, there is a problem in that the filtration efficiency of the filter is reduced.

It is preferred that the low-density portion B has an area corresponding to 1 to 15%, preferably 1.5 to 5% of the total area of the filter member. When the area of the low-density portion B is less than 1% of the total area of the filter member, the differential characteristic enhancement by the formation of the low-density portion B is insufficient. On the other hand when the area of the low-density portion B is more than 15%, there is a problem in that the particulate matter filtration efficiency of the filter is reduced because a large portion of the filter member has a reduced density.

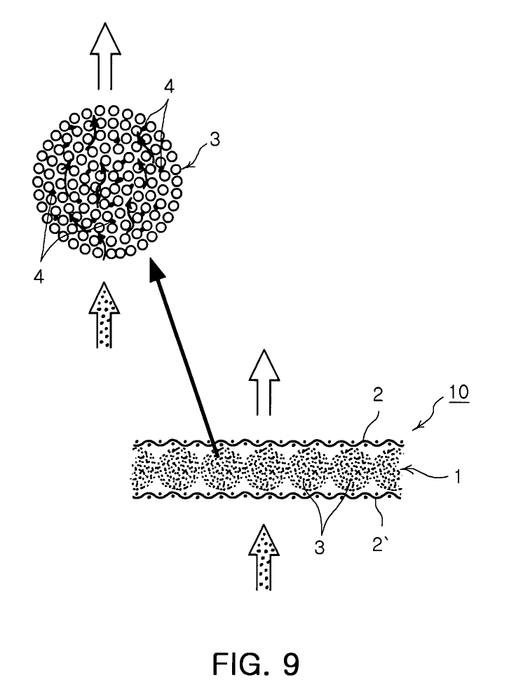

The low-density portion B has a density corresponding to 1 to 30% of the density of the remaining portion (non-low-density portion) of the filter member. When the density of the low-density portion B is less than 1% of the density of the non-low-density portion, the density of the low-density portion B is too low to sufficiently filter out particulate matter. On the other hand, when the density of the low-density portion B is more than 30%, the differential characteristic enhancement by the formation of the low-density portion B is insufficient because the density difference between the low-density portion and the non-low-density portion is too small. The density of the low-density portion may be adjusted by adjusting, for example, the porosity of the metal fibers constituting the metal fiber media as the filter member and/or the density of the metal fibers.

Where the metal fiber media according to the present invention is used as a filter member for diesel engine exhaust gas, the diesel engine exhaust gas passes through a large number of pores formed among the metal fibers of the metal fiber media and the yarns of the metal fiber media. Thus, a depth filter effect is obtained. FIG. 9 is a cross-sectional view of the metal fiber media 10 shown in FIG. 1, taken along the line A-A of FIG. 1. FIG. 9 illustrates the concept of collection of particulate matter 4 achieved by the metal fiber filter as diesel engine exhaust gas passes through the metal fiber filter, as in a depth filter.

In the filter of the present invention, an increased number of fine pores results in an enhancement in the efficiency of removing particulate matter from diesel engine exhaust gas. Accordingly, in the case of a filter manufactured using, as a filter member, a metal fiber media made of multiple layers of metal fiber yarns, a metal fiber media made of metal fiber yarns and metal fibers, and a corrugated metal fiber media, the number of metal fibers in the cross section of the filer is large by virtue of the large thickness of the metal fiber media. In this case, therefore, the surface area collecting particulate matter increases, and thus an enhancement in the efficiency of collecting particulate matter contained in exhaust gas is achieved.

In conventional catalyst-carried ceramic filters, alumina is coated on a ceramic filter body, to carry catalyst on the alumina. In the case of a filter, which is made of the metal fiber media according to the present invention, however, it is possible to carry a metal catalyst on the filter without using a separate alumina coating process, because the metal fibers of the metal fiber media are made of Fecralloy containing aluminum components, and aluminum oxidizes at a high temperature. In accordance with the present invention, the metal catalyst may be at least one selected from Pt, Pd, Rh, and Ru. Therefore, the coating of the catalyst on the filter can be more easily achieved in accordance with the present invention. In accordance with the present invention, the metal fiber media is heated at 500 to 1,200° C., preferably in an oxygen atmosphere, if necessary, for 1 to 24 hours, to oxidize aluminum contained in the metal fiber composition into alumina, and thus to enable the catalyst to be carried on the alumina. When heating is carried out at a temperature of less than 500° C. or for less than 1 hour, the oxidation of aluminum into alumina is insufficient. On the other hand, when the heating is carried out at a temperature of more than 1,200° C. or for more than 24 hours, there is a problem in that the expense is excessively high.

Results of comparison of the properties of Fecralloy used as the filter member of the present invention with those of cordierite and SiC used as conventional filter materials are as follows: Strength—1 Mpa in cordierite, 6 Mpa in SiC, and 540 Mpa in Fecralloy; Heat resistance—1,200° C. in cordierite, 1,600° C. in SiC, and 1,200° C. in Fecralloy; Heat transfer efficiency—2W/mk in cordierite, 6W/mk in SiC, and 16W/mK in Fecralloy; Thermal expansion coefficient—1×10⁻⁶° C.⁻¹ in cordierite, 4×10⁻⁶° C⁻¹ in SiC, and 11.1×10⁻⁶° C.⁻¹ in Fecralloy; melting point—1,450° C. in cordierite, 2,400° C. in SiC, and 1,530° C. in Fecralloy. Thus, the filter using the metal fiber media made of Fecralloy metal fibers as a filter member in accordance with the present invention exhibits superior strength, impact resistance, and heat transfer efficiency over conventional filters.

The filter may be used for a exhaust gas purifier. In detail, the filter may be used for a purifier for purifying exhaust gas generated in diesel engines and diesel generators.

Hereinafter, the present invention will be described in detail inconjunction with examples. These examples are made only for illustrative purposes, and the present invention is not to be construed as being limited to those examples.

### EXAMPLES

### Example 1

Two types of metal fiber filters according to this example were prepared as follows. A circular rod having a diameter of 12 mm was positioned near an induction coil of a melting apparatus shown in FIG. 3, and heated to 1,600° C., in order to melt an end of the rod, in accordance with a method disclosed in U.S. Pat. No. 6,604,570. The melted end of the rod was brought into contact with a disc rotating at a high speed of 20 m/sec, to instantaneously manufacture metal fibers having an equivalent diameter of 50 μm. The manufactured metal fibers were randomly oriented, and had a half-moon-shaped cross section while having a length of about 10 to 18 cm. The metal fibers had a composition of 22 weight % of chromium, 5.5 weight % of aluminum, 0.3 weight % of zirconium, and balance of iron (Fe).

The randomly-oriented metal fibers were continuously combed 100 times until 80 strands of unidirectionally-oriented metal fibers are formed, to form a yarn. The prepared metal fiber yarns had a length of 0.55 m per 1 g, and a torsion of 8 turns/m. Thereafter, the yarns were longitudinally aligned in two layers, to form a metal fiber mat. The metal fibers for the first type filter(Inventive Sample 1) had a density of 1.5 kg/m², whereas the metal fibers for the second type filter(Inventive Sample 2) had a density of 3.0 kg/m².

A metal fiber media was then prepared by attaching heat-resistant wire meshes having porosities of 45% and 72% to upper and lower surfaces of the metal fiber mat which had a porosity of 60%, respectively. The wire meshes had a composition of 18 weight % of chromium, 3.0 weight % of aluminum, and balance of iron (Fe). The prepared metal fiber media had a thickness of 1.0 mm, and an average pore size corresponding to an equivalent diameter of 40 μm.

The prepared metal fiber media was pleated to a depth of 10 mm, and then pressed at 1 kg/cm² to form a cylindrical filter member having a diameter of 70 mm, a length of 300 mm, and the number of corrugations of 52. Fixing members were mounted to opposite ends of the filter member, respectively. Thus, corrugated cylindrical filters (first and second types), which have a structure of FIG. 6A, were prepared. The cylindrical filters had a volume of 1.15 l.

### Example 2

In this example, a PM collection efficiency was measured for two filters prepared in Example 1 (Inventive Sample 1 and Inventive Sample 2) and two conventional filters (Conventional Sample 1 and Conventional Sample 2). For the conventional filters, cordierite filters manufactured in a wall-flow method proposed by Corning Inc. were used. For the first conventional filter(Conventional Sample 1), a filter, on which a catalyst of Pt is carried, was used. For the second conventional filter(Conventional Sample 2), a filter, on which no catalyst is carried, was used.

For a diesel engine used in the measurement, a 4-cylinder VGT diesel engine for a Santa Fe having a displacement of 2,000 cc while being equipped with an intercooler and a common rail system.

The measurement was carried out for a DPF mounted with two filters of the first type according to the present invention, and a DPF mounted with two filters of the second type according to the present invention, a DPF mounted with one filter of the first conventional type (diameter of 150 mm and length of 150 mm), and a DPF mounted with one filter of the second conventional type (diameter of 150 mm and length of 150 mm).

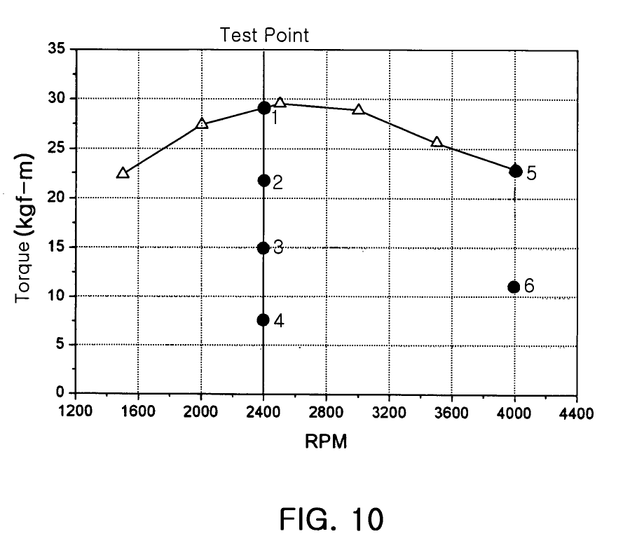

In the measurement, the PM collection efficiency for particulate matter contained in exhaust gas was measured under the conditions described in the following Table 1. The engine speed was 100 km/hr. The conditions of Table 1 were also depicted in FIG. 10.

TABLE 1

| | | | Amount of | Amount of |
|---|---|---|---|---|
| | | Full Load | Injected Fuel | Supplied |
| Condition No. | RPM | Torque (%) | (kg/hr.) | Air (kg/hr.) |
| 1 | 2,400 | 100 | 21.9 | 330 |
| 2 | | 75 | 16.5 | 280 |
| 3 | | 50 | 11.8 | 260 |
| 4 | | 25 | 6.9 | 180 |
| 5 | 4,000 | 100 | 33.8 | 500 |
| 6 | | 50 | 18.8 | 450 |

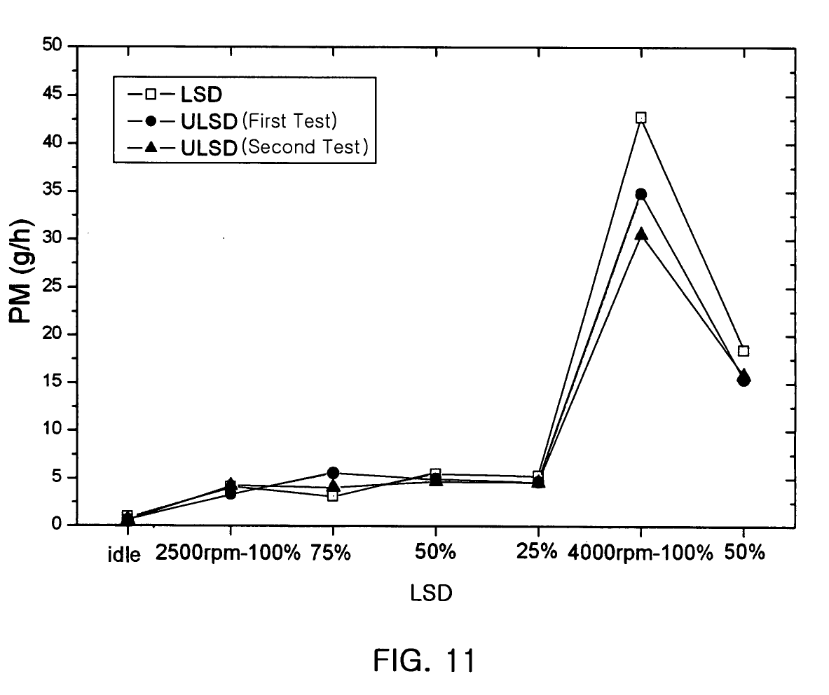

For comparison in terms of PM collection efficiency, the engine was driven using low-sulfur diesel fuel (LSD) and ultra-low-sulfur diesel fuel (ULSD; sulfur content of less than 50 ppm) under the above conditions, respectively. The amount of particulate matter generated when no DPF was used was also measured. The measured amount is shown in FIG. 11.

Referring to FIG. 11, it can be seen that, in the case of using no DPF, the amount of generated particulate matter gradually increased. In the case using LSD, about 45 g of particulate matter was generated per one hour at a full load torque and 4,000 rpm.

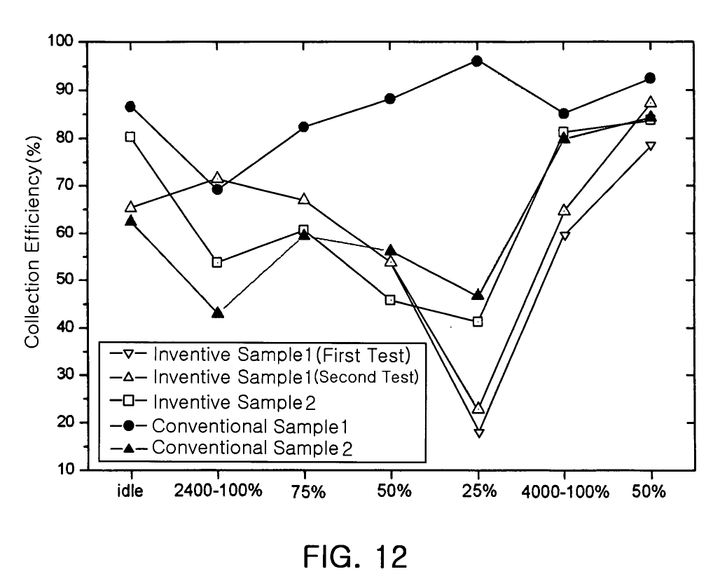

Each of the DPFs respectively mounted with the filters of the first and second types according to the present invention and the filters of the conventional first and second types in the above-described numbers was mounted to a downstream end of the diesel engine, to measure the PM collection efficiency for particulate matter contained in exhaust gas emitted from the diesel engine. The results of the measurement were depicted in FIG. 12. For the fuel, ULSD was used. The PM collection efficiency shown in FIG. 12 was calculated based on the PM collection efficiency measured in the case where no the filter was mounted in the filter of FIG. 11 was mounted and the PM collection efficiency measured in the case where no filter was mounted.

Referring to the graphs of FIG. 12, it can be seen that the case using the DPF mounted with the Pt-coated cordierite filter of the first conventional type exhibited a maximum PM collection efficiency. However, the cases using the DPFs mounted with the filters of the first and second types according to the present invention exhibited an excellent PM collection efficiency (PM removal efficiency) approximately equal to that of the cordierite filter of the second conventional type where no catalyst was coated. Accordingly, it can be seen that, when a catalyst is carried on the filter of the present invention, it is possible to obtain a PM removal efficiency approximately equal to that of the case using the Pt-coated cordierite filter of the first conventional type, by virtue of removal of SOF components.

Also, the filter of the second type according to the present invention having a high metal fiber density exhibited a PM collection efficiency superior over that of the first of the first type according to the present invention. Based on this result, it can be seen that it is possible to effectively collect and remove particulate matter contained in diesel engine exhaust gas, using the heat-resistant metal fiber media according to the present invention as a substitute for the conventional cordierite filter.

### Example 3

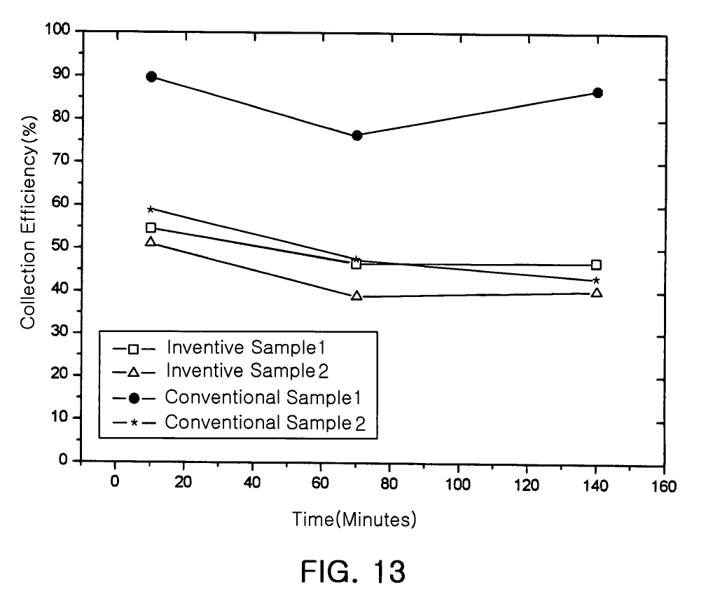

In this example, variations in the PM collection efficiencies of the filters of the first and second types according to the present invention and the filters of the first and second conventional types depending on the lapse of time were measured. The measurement was carried out for an engine drive time of 2 hours at a speed of 100 km/h, 4,000 rpm, and a full load torque. The results of the measurement are depicted in FIG. 13. In the measurement, the same engine, filters, and fuel as in Example 2 were used.

As shown in the graphs of FIG. 13, the case using the filter of the first conventional type exhibited a filtering efficiency of 80 to 90% during the engine operation. The filters of the first and second types according to the present invention, on which no catalyst was carried, exhibited a filtering efficiency of 40 to 60% similar to that of the filter of the second conventional type on which no catalyst was carried. Accordingly, it is expected that, when the filters according to the present invention are used in a catalyst-carried state, a filtering efficiency approximately equal to that of the filter of the first conventional type will be obtained. From the above results, it can also be seen that the filters of the present invention can be effectively used for collection of particulate matter contained in diesel engine exhaust gas, in place of the conventional cordierite filter.

### Example 4

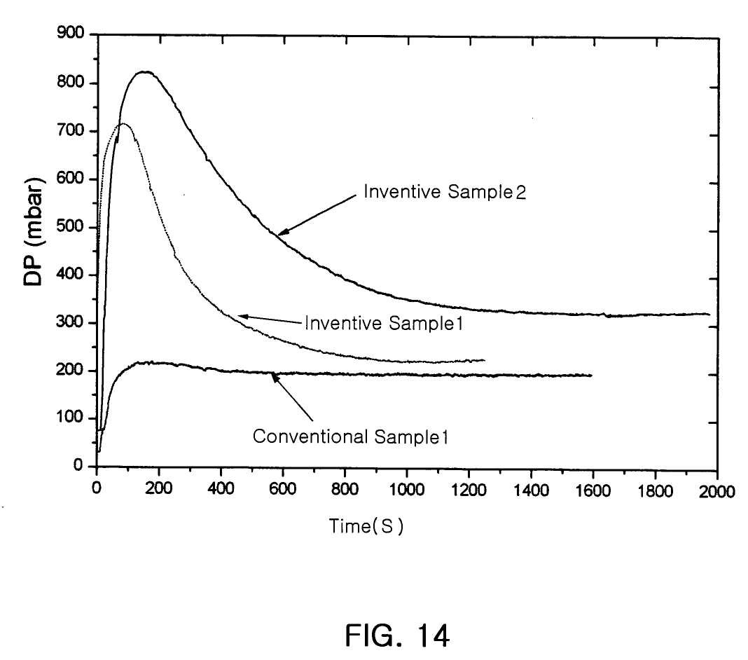

In this example, filter regeneration efficiency was observed in accordance with measurement of a variation in differential pressure (differential pressure (DP)) occurring during filter regeneration. The filter regeneration was carried out by burning the DPFs respectively mounted with the filters of the first and second types according to the present invention and the filter of the first conventional type for 20 minutes under conditions using 4,000 rpm and a full load torque. A variation in differential pressure occurring in association with each DPF during the burning was observed. The results of the observation are depicted in FIG. 14.

Referring to the graphs of FIG. 14, it can be seen that the filters of the first and second types according to the present invention generate a high differential pressure at the initial stage of the regeneration process, but generate a reduced differential pressure similar to that of the cordierite filter of the first conventional type after about 1 minute and 30 seconds. Accordingly, it is expected that the regeneration times of the filters according to the present invention are not longer than that of the conventional filter. Thus, the metal fiber media according to the present invention is re-usable after regeneration.

Also, there is no possibility of damage caused by a local regeneration temperature increase because Fecralloy has a heat transfer efficiency of 14W/mK considerably higher than the heat transfer efficiency of cordierite, namely 1W/mK.

### Example 5

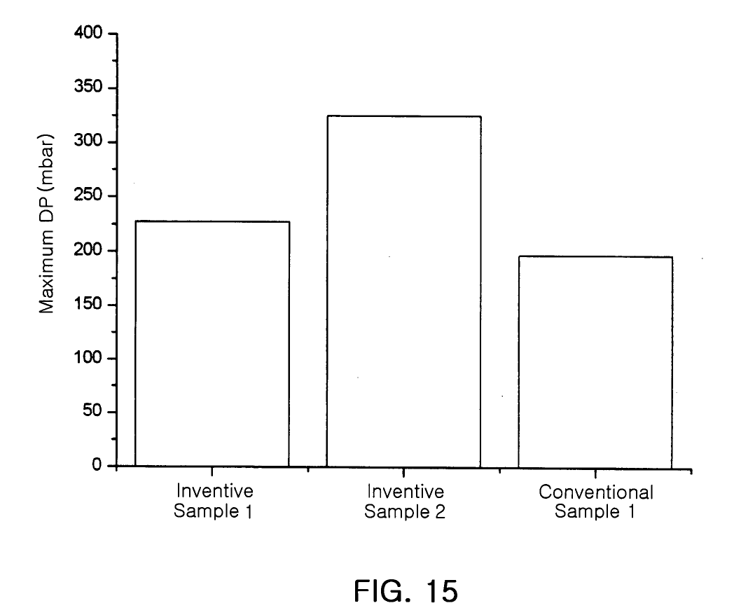

In this example, a measurement of maximum back pressure was carried out for the filters of the first and second types according to the present invention and the filter of the second conventional type under conditions using 4,000 rpm and a full load torque after the filter regeneration. The results of the measurement are depicted in FIG. 15. The differential pressure (DP) is a difference of pressure filter between the upstream and downstream ends of the filter. Low differential pressure means that the filter is not blocked, thereby allowing exhaust gas to easily pass through the filter. Referring to FIG. 15, it can be seen that the filters of the first and second types according to the present invention exhibit a differential pressure enabling the filters to be used, at 4,000 rpm and a full load torque after the regeneration.

### Example 6

The example shows variations in differential pressure depending on the particulate matter collection of a filter having a low-density portion and a filter having no low-density portion.

In this example, for the filter having no low-density portion, the filter of the second type according to the present invention was used. For the filter having the low-density portion, a filter (hereinafter, referred to as a third type filter of the present invention (Inventive Sample 3)) was used that has the same structure as the second type filter of the present invention, except that the filter has a low-density portion having an area corresponding to 3% of the total area of the filter member while having an outlet arranged at a position of −40% from the center of the filter. The low-density portion was formed using metal fibers having a density of 0.9 kg/m².

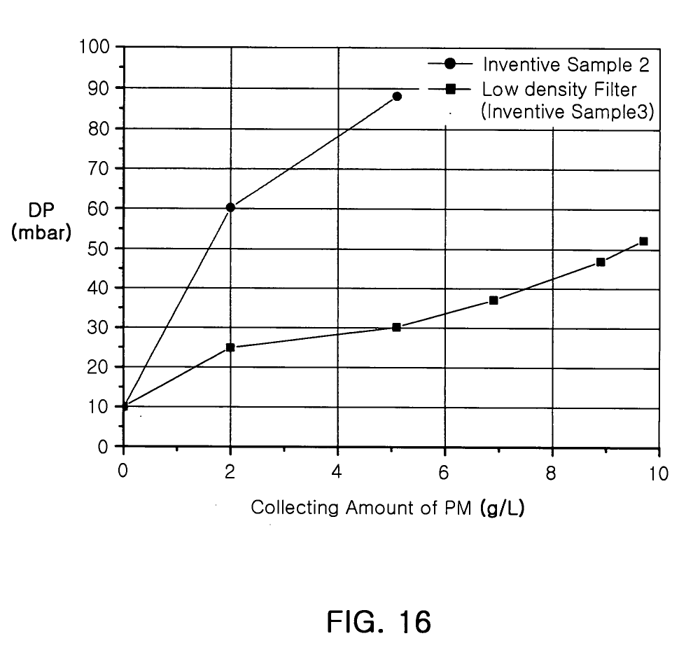

In this example, a variation in differential pressure depending on the collected amount of particulate matter was measured at a speed of 100 km/h, 1,800 rpm, a full load torque, a fuel supply amount of 21.9 kg/hr, and an air supply amount of 330 kg/hr. The results are depicted in FIG. 16. For the fuel, ultra-low-sulfur diesel fuel (ULSD; sulfur content of less than 50 ppm) was used.

Referring to FIG. 16, it can be seen that, when the amount of collected particulate matter is 2 g/L, the third type filter of the present invention exhibits a differential pressure of 25 mbar, whereas the second type filter of the present invention exhibits a differential pressure of 60 mbar. Accordingly, it can be seen that a filter having the low-density portion has enhanced differential characteristics.

As apparent from the above description, the filter which uses, as a filter member, the metal fiber media according to the present invention, for use in an exhaust gas purifier exhibits excellent characteristics in terms of durability, mechanical strength, and heat transfer efficiency because it is made of a metal material. Since the metal fiber media of the present invention exhibits excellent durability and mechanical strength, no crack is generated in the metal fiber medial due to external impact. Accordingly, there is no possibility of damage. Since the metal fiber media has excellent heat transfer efficiency, uniform heat transfer is achieved during soot burning for regenerating the filter. Accordingly, there is no damage of the filter caused by local heating. It is also possible to prevent the material of the filter from being melted. Thus, an excellent filter regeneration effect is obtained. Furthermore, the metal fiber media of the present invention exhibits superior workability because the metal thereof is not rendered fragile in that they are manufactured without being subjected to a sintering process. In addition, the filter of the present invention exhibits collection efficiency for particulate matter contained in diesel engine exhaust gas approximately equal to those of the conventional filters made of cordierite and sintered metal mat.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A filter for an exhaust gas purifier comprising:
a metal fiber media as a filter member, the metal fiber media comprising a metal fiber mat made of a plurality of unidirectionally-oriented metal fibers, the metal fiber mat having a porosity of 30 to 95%, and supports respectively attached to upper and lower surfaces of the metal fiber mat, the supports having a porosity of 5 to 95%.

2. A filter for an exhaust gas purifier comprising:
a metal fiber mat as a filter member, the metal fiber media comprising a metal fiber mat made of longitudinally-aligned metal fiber yarns each including a bundle of 20 to 500 uniformly-oriented metal fibers and having a length of 0.45 to 0.6 m per 1 g, and a torsion of 1 to 9 turns/m, the metal fiber mat having a porosity of 5 to 95%, and supports respectively attached to upper and lower surfaces of the metal fiber mat, the supports having a porosity of 5 to 95%.

3. The filter according to claim 1 or 2, wherein the metal fibers have a density of 100 to 4,000 g/m².

4. The filter according to claim 1 or 2, wherein the metal fiber mat has a longitudinal laminated structure of at least two layers.

5. The filter according to claim 1 or 2, wherein the metal fiber media as a filter member has a corrugated structure.

6. The filter according to claim 5, wherein the corrugation structure has a depth of 3 to 30 mm.

7. The filter according to claim 1 or 2, wherein the metal fibers have an equivalent diameter of 10 to 150 μm.

8. The filter according to claim 1 or 2, wherein the metal fiber media has an average pore size corresponding to an equivalent diameter of 10 to 250 μm.

9. The filter according to claim 1 or 2, wherein the metal fiber media has a thickness of 0.5 to 3 mm.

10. The filter according to claim 1 or 2, wherein the filter member comprises a tubular filter member or a plurality of telescopically-arranged tubular filter members such that the filter has a tubular structure or a multi-tubular structure.

11. The filter according to claim 10, wherein the tubular filter member has a cylindrical structure having a circular cross section.

12. The filter according to claim 10, wherein the tubular filter member has a corrugated cylindrical structure.

13. The filter according to claim 10, wherein, when the filter has the tubular structure, the filter has a ratio of equivalent diameter to length of 1:1.5 to 15.

14. The filter according to claim 10, wherein, when the filter has the tubular structure, the filter has corrugations, the number of the corrugations being less than 15 times an equivalent diameter of the filter when the equivalent diameter is expressed in centimeters.

15. The filter according to claim 1 or 2, wherein the exhaust gas purifier, in which the filter is used, is adapted to purify exhaust gas emitted from a diesel engine or a diesel generator.

16. The filter according to claim 1 or 2, further comprising:
a low-density portion arranged within a longitudinal range of ±40% from a center of the filter.

17. The filter according to claim 1 or 2, wherein the low-density portion has an area corresponding to 1 to 15% of an area of the filter member.

18. The filter according to claim 1 or 2, wherein the low-density portion has a density corresponding to 1 to 30% of a density of non-low-density portion.
